(19) United States
(12) Patent Application Publication
(10) Pub. No.: US 2009/0154177 A1
(43) Pub. Date: Jun. 18, 2009

(54) HINGE FOR A LAMP

(75) Inventors: HAO LI, Shenzhen City (CN); YONG-DONG CHEN, Shenzhen City (CN); SHIH-HSUN WUNG, Tu-Cheng (TW)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/147,493

(22) Filed: Jun. 27, 2008

(30) Foreign Application Priority Data
Dec. 12, 2007 (CN) 200710125002.3

(51) Int. Cl. F21S 8/00; F21S 13/10

(52) U.S. Cl. 362/427; 362/431

(57) ABSTRACT

A lamp hinge includes a first connector and a second connector pivotally connecting with the first connector. The first connector is formed on an upper end of a lamp pole and defines a circular chamber therein. The second connector is for connecting with a lamp head. Two arced engaging portions are formed on the second connector and are pivotally received in the chamber. The arced engaging portions are distributed in a same annulus and define a first arced gap and a second arced gap therebetween, adapted for providing passage of electric wires of the lamp. The first arced gap is communicated with a central hole of a mounting portion of the second connector. The second arced gap is communicated with a recessed portion of the lamp pole. The second arced gap is longer than five twelfths of a perimeter of the annulus where the arced engaging portions are distributed.

### BACKGROUND OF THE INVENTION

1. Field of the Invention

The present invention relates to a hinge, and more particularly to a hinge for connecting a lamp head and a lamp stand of a lamp, for example, a table lamp.

2. Description of Related Art

In a variety of conventional lamps, the projecting angle of a lamp is generally adjusted by means of a hinge connecting a lamp head with a lamp stand. Electric wires extend from the lamp stand through the hinge to reach the lamp head.

Referring to FIG. 5, a related lamp hinge (not labeled) comprises a first connector 29 integrally formed on a top of a lamp pole 20 which has a bottom end for connecting with a lamp stand (not shown) and a second connector 11 pivotably connected to the first connector 29 and for connecting with a lamp head (not shown). The second connector 11 can rotate relative to the first connector 29. The lamp pole 20 comprises a pair of shells 21, 22. The second connector 11 comprises a pivotal portion 15 pivotally received in the first connector 29. The pivotal portion 15 evenly forms three protruding portions 17, 18, 19 circumferentially distributed at a side thereof. Each protruding portion 17, 18, 19 has a cylindrical configuration. The protruding portions 17, 18, 19 are pivotally received in a groove 220 of the first connector 29. During assembly of the lamp, electric wires of the lamp extend through a gap between the protruding portions 17, 18 or between the protruding portions 18, 19. When the second connector 11 rotates relative to first connector 29, the electric wires may be abraded by the protruding portion 18 located between the protruding portions 17, 19. Furthermore, because of small contacting area between the protruding portions 17, 18, 19 and the first connector 29, the protruding portions 17, 18, 19 are prone to be easily worn and a lifespan of the lamp will be reduced. There is a need to provide a hinge for a lamp which will not abrade the electric wires when the hinge is rotated. Furthermore, the hinge can have a robust structure so that that it can have a longer life of use.

### SUMMARY OF THE INVENTION

A lamp hinge includes a first connector and a second connector pivotally connecting with the first connector. The first connector is integrally formed on an upper end of a lamp pole and defines a circular chamber therein. A lower end of the lamp pole is for connecting with a lamp stand. The second connector is for connecting with a lamp head. Two arced engaging portions are formed on the second connector and are pivotally received in the chamber of the first connector. The arced engaging portions are distributed in a same annulus and define a first arced gap and a second arced gap therebetween, adapted for providing passage of electric wires of the lamp through the lamp hinge. A central hole is axially extended through a mounting portion of the second connector. The mounting portion is for connecting with the lamp head. The electric wires also extend through the central hole. The first arced gap is communicated with the central hole of the mounting portion of the second connector. The second arced gap is communicated with a recessed portion of the lamp pole. The second arced gap is longer than five twelfths of a perimeter of the annulus where the arced engaging portions are distributed. Thus, the electric wires can be prevented from being abraded by the engaging portions of the second connector when the second connector rotates relative to the first connector to adjust the projecting angle of the lamp head.

### BRIEF DESCRIPTION OF THE DRAWINGS

Many aspects of the present hinge can be better understood with reference to the following drawings. The components in the drawings are not necessarily drawn to scale, the emphasis instead being placed upon clearly illustrating the principles of the present hinge. Moreover, in the drawings, like reference numerals designate corresponding parts throughout the several views.

FIG. 1 is an assembled, isometric view of a lamp hinge for connecting with a lamp head and a lamp stand in accordance with a preferred embodiment of the present invention.

FIG. 2 is an exploded, isometric view of the lamp hinge of FIG. 1.

FIG. 3 is an isometric view of a second connector of the lamp hinge of FIG. 2.

FIG. 4 is a view similar to FIG. 3, but viewed from a different aspect.

FIG. 5 is an isometric view of a related lamp hinge.

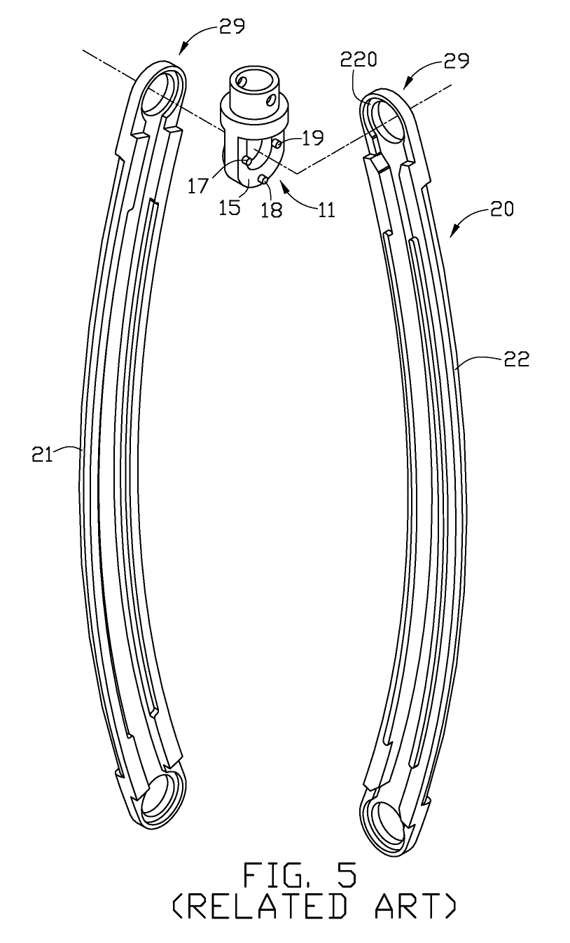

### DETAILED DESCRIPTION OF THE INVENTION

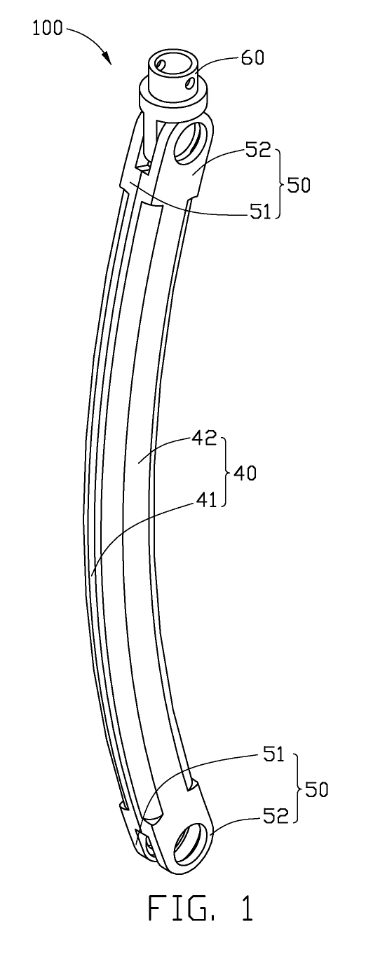

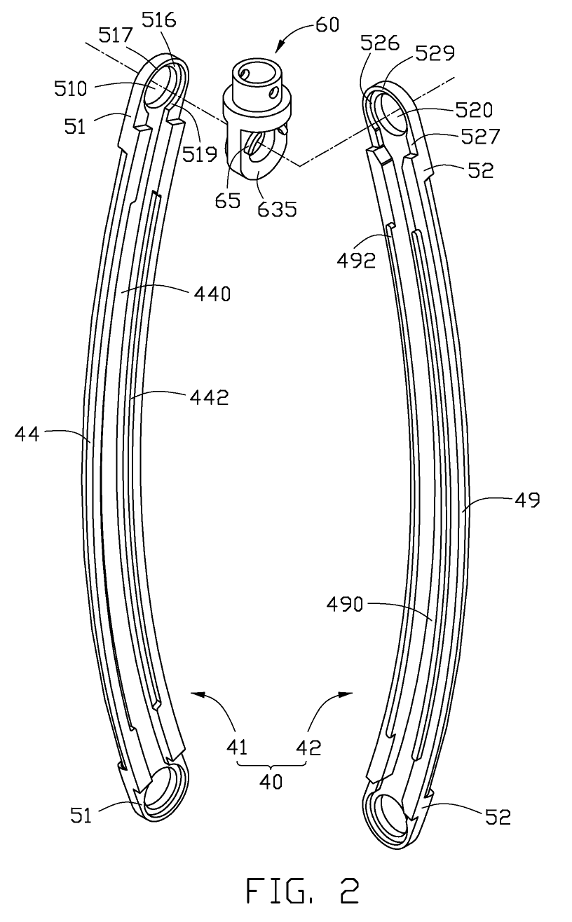

Referring to FIGS. 1-2, a hinge 100 of an adjustable lamp of a preferred embodiment of the invention is shown. The hinge 100 is for connecting a lamp head (not shown) to a lamp stand (not shown). The hinge 100 is provided at an upper end of a lamp pole 40. The hinge 100 comprises a first connector 50 and a second connector 60. The first and second connectors 50, 60 form a union swivel to permit the lamp head to rotate axially relative to the lamp pole 40. The first connector 50 can be fastened on the lamp pole 40 or integrally made with the lamp pole 40. In this embodiment, the first connector 50 is integrally made with the lamp pole 40. The second connector 60 is fastened on the lamp head. Electric wires (not shown) extend through the first and second connectors 50, 60 and the lamp pole 40 for electrically connecting the lamp head and the lamp stand. Another first connector 50 is formed on a lower end of the lamp pole 40. Another second connector (not shown) is pivotally received in the another first connector 50 and connects the lamp pole 40 and the lamp stand (not shown).

The lamp pole 40 is formed of an elongated first shell 41 and a second shell 42. The first and second shells 41, 42 contact each other to form an elongated receiving room therebetween which permits the electric wires to extend therein. The first connector 50 comprises a first engaging part 51 formed at an upper end of the first shell 41 and a second engaging part 52 formed at an upper end of the second shell 42. The second connector 60 is sandwiched between the first and second engaging parts 51, 52 and pivotally engages with the first and second engaging parts 51, 52.

The first shell 41 has two contacting portions 44 protruding from two lateral edges on an inner side thereof and an elongated recessed portion 440 between the contacting portions 44. The contacting portions 44 each define a cutout 442 near the elongated recessed portion 440. The second shell 42 is similar to the first shell 41, having two contacting portions 49 protruding from two lateral edges thereof and an elongated recessed portion 490 between the contacting portions 49. The contacting portions 49 each protrude an elongated rib 492 corresponding to each cutout 442 of the first shell 41.

The first engaging part 51 of the first connector 50 has a circular profile and transversely defines an axle hole 510 therein. The first engaging part 51 has a base portion 516 lower than the contacting portions 44 of the first shell 41; an annular wall 519 is formed on the base portion 516 and surrounds the axle hole 510. The annular wall 519 is perpendicular to the base portion 516. The recessed portion 440 of the first shell 41 extends to the annular wall 519 and communicates with the axle hole 510. The annular wall 519 has a top contacting face 517.

The second engaging part 52 of the first connector 50 has a profile similar to the first engaging part 51 and defines transversely an axle hole 520. The second engaging part 52 has a base portion 526 lower than the contacting portions 49 of the second shell 42, and an annular wall 529 formed on the base portion 526 and surrounding the axle hole 520. The recessed portion 490 of the second shell 42 extends to the annular wall 529 and communicates with the axle hole 520. The annular wall 529 has a top contacting face 527.

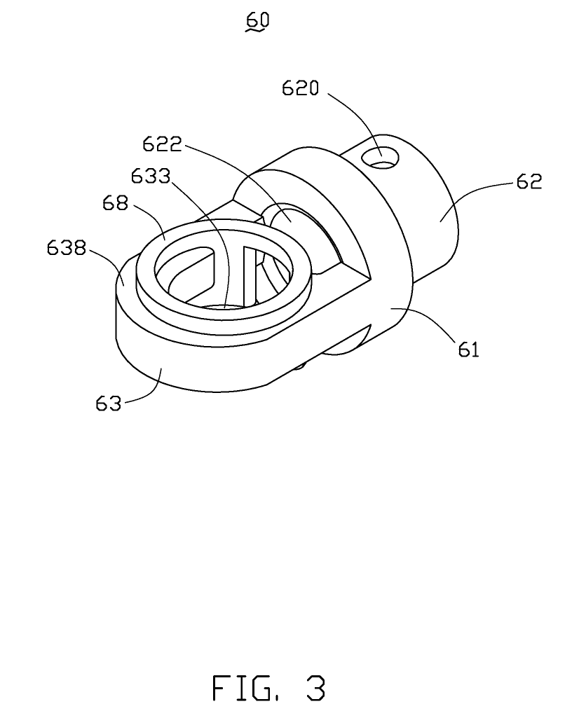

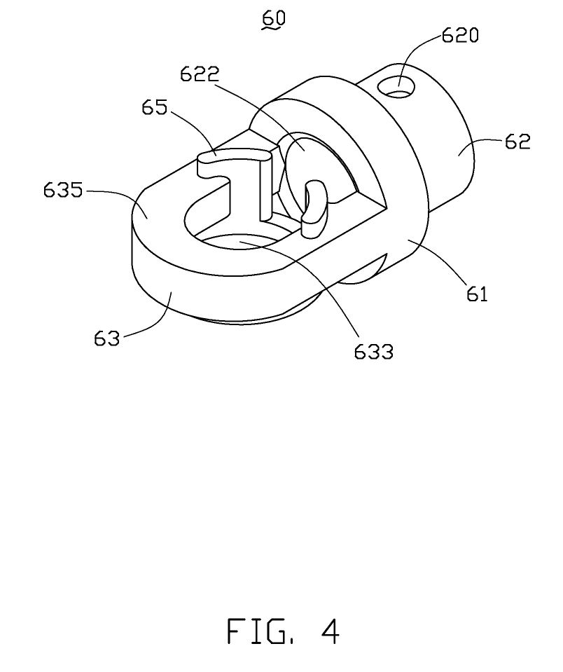

Referring to FIGS. 3-4 together, the second connector 60 comprises a main body 61, a mounting portion 62 extending upwardly from a top of the main body 61, and a pivotal portion 63 extending downwardly from the main body 61. The mounting portion 62 and the main body 61 each have an annular configuration and have a common axis. A central hole 622 is defined through the mounting portion 62 and the main body 61. The mounting portion 62 has two mounting holes 620 for extension of a fastener (not shown) therethrough for securing the lamp head to the second connector 60. The pivotal portion 63 has a U-shaped configuration with two ends connecting with the main body 61. The pivotal portion 63 has two parallel U-shaped side faces 635, 638. The pivotal portion 63 defines a through hole 633 through the side faces 635, 638. The through hole 633 communicates perpendicularly with the central hole 622 of the mounting portion 62 and the main body 61. An annular protruding portion 68 protrudes from the side face 638 of the pivotal portion 63. The protruding portion 68 has the same height as that of the annular wall 519 of the first engaging part 51 of the first connector 50. Thus, the protruding portion 68 can be pivotally received in a chamber defined by the annular wall 519 of the first connector 50.

The pivotal portion 63 forms vertically two arced engaging portions 65 from the side face 635 thereof. A part of the annular protruding portion 68 interconnects inner, upper, spaced ends of the engaging portions 65. The engaging portions 65 have outer, lower, spaced ends opposite to the upper ends thereof. The arced engaging portions 65 are parallel to and coincidental with corresponding parts of the protruding portion 68. Each engaging portion 65 has the same thickness as that of the annular wall 529 of the second engaging part 52. Thus, the engaging portion 65 can be pivotally received in the chamber of the second engaging part 52. The engaging portions 65 are distributed in a same annulus and each engaging portion 65 is shorter than a quarter of a perimeter of the annulus. In this embodiment, each engaging portion 65 has an arced length accounting for one-sixth of a perimeter of the annulus. A first arced gap (not labeled) is defined between the upper ends of the engaging portions 65, and a second arced gap (not labeled) is defined between the lower ends of the engaging portions 65. The electric wires extend through the central hole 622, the first arced gap between the upper ends of the engaging portions 65, the second arced gap between the lower ends of the engaging portions 65, and the lamp pole 40 in sequence. The second arced gap can be longer than five twelfths of a perimeter the annulus which the arced engaging portions 65 are located in. In this embodiment, the second arced gap is longer than half perimeter of the annulus, and the first arced gap has a width substantially the same as a diameter of the central hole 622.

During assembly of the hinge 100, the first and second shells 41, 42 of the lamp pole 40 contact each other with the ribs 492 of the second shell 42 engaged in the cutouts 442 of the first shell 41. The pivotal portion 63 of the second connector 60 is sandwiched between the first and second engaging parts 51, 52 of the first connector 50. The protruding portion 68 and the engaging portions 65 are respectively pivotally received in the chambers defined by the annular walls 519, 529 of the first and second engaging parts 51, 52. The side face 638 of the pivotal portion 63 contacts the top contacting face 517 of the first engaging part 51, and the side face 635 of the pivotal portion 63 contacts the top contacting face 527 of the second engaging part 52. The second connector 60 can rotate an angle relative to the first connector 50 so that the lamp head can be adjustable respective to the lamp pole 40. A retainer (not shown) such as a shaft can be inserted into the axle holes 510, 520 of the first connector 50 and the through hole 633 of the second connector 60. The retainer secures the first and second connectors 50, 60 and permits the second connector 60 to rotate in the first connector 50.

After assembly of the hinge 100, the first arced gap defined between the upper ends of the engaging portions 65 of the second connector 60, and the second arced gap defined between the lower ends of the engaging portions 65 communicate with the central hole 622 of the mounting portion 62 and the recessed portions 440, 490 of the lamp pole 40. The electric wires extend through the lamp pole 40 and the first and second connectors 50, 60 by extending through the recessed portions 440, 490 of the lamp pole 40, the first and second arced gaps and the central hole 622 in sequence. When the second connector 60 rotates relative to the first connector 50, the electric wires will not unduly driven by the engaging portions 65 to move therewith because the enough length of the second arced gap defined between the lower ends of the engaging portions 65. As a result, the abrasion of the electric wires by the pivoting engaging portions 65 can be prevented; thus, a damage to the electric wires due to the pivoting movement of the hinge 100 can be avoided. Additionally, the engaging portions 65 of the second connector 60 each have an arced structure so as to enlarge a contact area between the first and second connectors 50, 60 for prolonging a lifespan of the hinge 100.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge for a lamp comprising:
a first connector formed on an upper end of a lamp pole, the first connector defining a circular chamber therein; and
a second connector adapted for connecting with a lamp head, having two arced engaging portions formed on the second connector and being pivotally received in the chamber of the first connector, the arced engaging portions being distributed in a same annulus and defining a first arced gap and a second arced gap therebetween adapted for providing passage of electric wires of the lamp, the first arced gap communicating with a central hole of a mounting portion of the second connector, the mounting portion being adapted for connecting with the lamp head, the second arced gap communicating with a recessed portion of the lamp pole, the second arced gap being longer than five twelfths of a perimeter of the annulus where the arced engaging portions are distributed.

2. The hinge as described in claim 1, wherein the second arced gap is longer than half perimeter of the annulus where the arced engaging portions are distributed.

3. The hinge as described in claim 1, wherein each of the engaging portions is shorter than a quarter of a perimeter of the annulus where the arced engaging portions are distributed.

4. The hinge as described in claim 3, wherein each of the engaging portions has an arced length accounting for one-sixth of a perimeter of the annulus.

5. The hinge as described in claim 1, wherein the second connector comprises a U-shaped pivotal portion extending from the mounting portion, the arced engaging portions being formed on the pivotal portion.

6. The hinge as described in claim 5, wherein the pivotal portion defines a through hole, the first arced gap communicating with the through hole of the pivotal portion and the central hole of mounting portion, the second arced gap communicating with the through hole of the pivotal portion and the recessed portion of the lamp pole, the through hole being oriented perpendicular to the central hole.

7. The hinge as described in claim 5, wherein the pivotal portion extends an annular protruding portion from a side thereof opposite to the engaging portions.

8. The hinge as described in claim 7, wherein the engaging portions are parallel to corresponding arced parts of the protruding portion.

9. The hinge as described in claim 5, wherein the first connector comprises a first engaging part and a second engaging part, the first and second engaging parts sandwiching the pivotal portion of the second connector therebetween.

10. The hinge as described in claim 9, wherein the chamber is defined at an inner side of one of the first and second connectors corresponding to the engaging portions.

11. The hinge as described in claim 9, wherein the first and second engaging parts each define an axle hole adapted for inserting a retainer to secure the first and second connectors together.

12. The hinge as described in claim 11, wherein the first engaging part has a circular base portion and an annular wall formed on the base portion and surrounding the axle hole of the first engaging part.

13. The hinge as described in claim 11, wherein the second engaging part has a circular base portion and an annular wall formed on the base portion and surrounding the axle hole of the second engaging part.

14. The hinge as described in claim 1, wherein the first connector is integrally made with the lamp pole.
